(19) United States
(12) Patent Application Publication
(10) Pub. No.: US 2015/0291451 A1
(43) Pub. Date: Oct. 15, 2015

(54) ELECTROCHEMICAL SYSTEM AND PROCESS FOR THE REDUCTION OF NITRIC ACID CONCENTRATION USING ELECTROLYTIC CELL

(71) Applicant: COUNCIL OF SCIENTIFIC & INDUSTRIAL RESEARCH, Delhi (IN)

(72) Inventors: Subbaiah Tondepu, Bhubaneswar (IN); Barada Kanta Mishra, Bhubaneswar (IN); Sanjay Kali, Bhubaneswar (IN); Chinmaya Kumar Sarangi, Bhubaneswar (IN); Avijit Biswal, Bhubaneswar (IN); Satyabrata Mishra, Kalpakkam (IN); Mallika Chellanadar, Kalpakkam (IN); Kamachi Mudali Uthandi, Kalpakkam (IN); Natarajan Rajamani, Kalpakkam (IN); Raj Baldev, Kalpakkam (IN)

(21) Appl. No.: 14/435,343

(22) PCT Filed: Oct. 14, 2013
(86) PCT No.: PCT/IN2013/000620

§ 371 Date: Apr. 13, 2015

(30) Foreign Application Priority Data
Oct. 12, 2012 (IN) 3198/DEL/2012

(51) Int. Cl. C02F 1/467; C02F 1/461

(52) U.S. Cl. CPC C02F 1/4676; C02F 1/46176; C02F 1/46109; C02F 2001/46142; C02F 2201/46185; C02F 2201/4611

(57) ABSTRACT

The present invention discloses an electrochemical system and process for the reduction of nitric acid concentration present in industrial waste using electrolytic cell. The present invention further relates to an electrochemical process for the reduction of nitric acid concentration using an electrolytic cell useful in reducing the volume of the high level liquid waste solution (HLLW) and avoiding corrosion of the storage tanks for high level liquid waste solution (HLLW).

### FIELD OF THE INVENTION

The present invention relates to an electrochemical system and process for the reduction of nitric acid concentration using an electrolytic cell. More particularly, the present invention relates to a continuous process for reduction of nitric acid useful in reducing the volume of the high level liquid waste solution (HLLW) and avoiding corrosion of the storage tanks for HLLW.

### BACKGROUND OF THE INVENTION

Industrial waste solutions containing nitric acid in harmful concentrations must not be discharged into streams, rivers or other surface waters, especially not into those which are used for drinking water supplies, without prior treatment. For radioactive waste solutions, those produced in plants for the reprocessing of spent nuclear fuels, a process must be available which can reduce the concentration and/or volume as far as possible with a reasonable economy so that the waste solutions can be ultimately stored for a long time without a hazard of dangerous radionuclides getting into the biological cycle.

Hence, in the field of radioactive waste management, subjects of great concern include immobilization, volume reduction, and removal of radioactive substances and minimization of secondary radioactive waste generation. After the reprocessing of irradiated nuclear fuel for the recovery of U and Pu, the high level liquid waste (HLLW) solution contains radioactive fission products in 4 M nitric acid. For the storage of this liquid waste prior to its treatment for disposal, it is desirable to reduce the waste volume which is achieved by destroying the concentration followed by evaporation. The most significant methods for the destruction of nitric acid include biological denitration, calcinations, chemical reduction and electrochemical destruction.

Reference is made to Miao Li a, b, Chuanping Fenga, Zhenya Zhangb, Norio Sugiura, Electrochimica Acta 54 (2009) 4600-4606. IrO₂ coated titanium has been used for the nitrate removal, thereby the concentration of nitrate ions was very low in the electrolyte which is about 100 mg/L (Li et al., 2009) in comparison to 252 g/L or 4 M nitric acid used in the present invention. Apart from this, Li et al. studied the nitrate removal in a batch mode up to 3 h only whereas our invention is based on continuous mode of electrochemical reduction of nitric acid that is intended towards the development of a suitable technology for reduction of nitric acid content in a concentrated solution.

Reference is made to T. Mimori, K. Miyajima, K. Nemoto, T. Nakano, H. Masui, T. Mori and H. Takahashi, U.S. Pat. No. 5,476,989 (1995) where biological denitration reduces nitrate to gaseous N₂, N₂O or NO using a broad range of bacteria in the presence of reducing organic nutrients such as methanol, methane, glucose and starch. This technology is slow, difficult to control and produces an organic residue. Reference is made L. A. Bray, Report HW-76973 (1963) where chemical denitration is accomplished with reductants such as sugar, molasses, phosphorous, glycerin, formaldehyde, formic acid and ethyl alcohol. Citric acid, tartaric acid and EDTA are reported to be effective denitrating agents in the presence of radiation.

Reference is made to L. A. Bray and E. C. Martin, Report HW-75565 (1962); U.S. Pat. No. 3,158,577 (1964) where sugar had been tried as a reducing agent for nitrates by Bray and Martin and found that the efficiency depends on the concentration of dissolved metal ions like Fe, Cr etc. at 85 to 100° C.

Reference is made to T. V. Healy, J. Appl. Chem., 8 (1958) 553 and S. V. Kumar, M. N. Nadkarni, P. C. Mayankutty, N. S. Pillai and S. S. Shinde, Report BARC-781 (1974) where chemical reduction of nitric acid is carried out by means of a homogeneous reaction with formaldehyde.

Reference is made to Y. Kondo and M. Kubota, J. Nucl. Sci. Technol., 29 (1992) 140 and S. Drobnik, W. Hild, F. Kaufmann and H. Koschorke, U.S. Pat. No. 4,144,186 (1979) where formic acid is used for reduction of nitric acid.

Reference is made to Y. Kondo, J. Radioanal. Nucl. Chem., 240 (1999) 123; 242 (1999) 515 where denitration reaction is carried out with HCHO/HCOOH induced by nitrite.

Reference is made to A. Miyazaki, K. Shibazaki and I. Balint, J. Colloid Interface Sci., 293 (2006) 43 where catalysts like active carbon is used.

In another reference J. C. Broudic, P. Brossard and A. Ananiev, U.S. Pat. No. 6,383,400 (2002) noble metal supported catalysts are extensively studied.

The reaction of HCHO with nitric acid leaves no residual chemical from the reaction and the gaseous products are removed automatically. However, the reaction of HNO₃ with HCHO is initiated after a certain induction period during which the auto catalyst HNO₂ accumulates in the solution up to a threshold concentration (ranging between 10⁻² and 10⁻¹ M) beyond which the reaction develops rapidly. This delay can be detrimental as the denitration following the induction period can be violent and lead to uncontrollable process conditions and is a significant safety concern.

Reference is made to H. Schmieder and R. Kroebel, U.S. Pat. No. 4,056,482 (1977) and Y. Suzuki, H. Shimizu, M. Inoue, M. Fujiso, M. Shibuya, F. Iwamoto, Y. Outou, E. Ochi and T. Tsuyuki, Proc. 5^{th} Internatl. Conf. Recycling, Conditioning and Disposal (RECOD 98), France, Vol. 3, 1998, p. 838, where electrochemical denitration offers an easily controlled and safe mode of the destruction of nitrate ions without the requirement of chemical addition.

Reference is made to S. Drobnik, U.S. Pat. No. 3,673,086 (1972), where nitric acid, nitrate ions and nitrite ions are removed from aqueous radioactive waste solutions by treating such solutions with reducing agent.

Yet another reference is made to J. C. Broudic et al., U.S. Pat. No. 6,383,400 B1 (2002), where the nitrate and/or nitric acid concentration of an aqueous solution was reduced by means of a reaction with formic acid or formaldehyde wherein said reaction was carried out in heterogeneous catalysis.

However, chemical method of treating waste solution is inadequate in reducing the volume (owing to the corrosion of the reactor vessel), although it is able to reduce the concentration under stringent and unsafe conditions of treatment with high incubation period if the process temperature is not maintained at about 100° C. The commercial application of nitrate reduction by electrochemical techniques is underway.

The drawbacks of the chemical method are that the reaction is hard to control, foaming occurs in the presence of degraded organics and polymerization of formaldehyde must be anticipated. In this type of reaction, the induction period is rather high during which period nitrous acid, HNO₂ accumulates in the solution up to a threshold concentration causing rapid reaction. The induction period and the autocatalytic breakdown of nitric acid are the essential causes of the problems involved in this process.

### OBJECTIVES OF THE INVENTION

The main object of the present invention is to provide an electrochemical system and process for the reduction of nitric acid concentration using electrolytic cell.

Another object of the present invention is to provide an electrochemical system using diaphragm less electrolytic cell for the electrolytic reduction of nitric acid present in the radioactive waste solution.

Another object of the present invention is to provide a process to reduce the acidity of the radioactive waste solution by electrolytic acid killing of nitric acid from a concentration level of about 4M to around 1M in a continuous mode of operation.

Yet another object is to provide a proper selection of cathode material to withstand high current in corrosive environment.

Yet another object is to provide a process with optimized cell potential in order to minimize the energy loss by suppressing the unwanted side reactions.

### SUMMARY OF THE INVENTION

Accordingly, the present invention provides an electrochemical system for electrolytic reduction of nitric acid concentration in industrial waste comprising a storage tank ST101 connected to a mixing tank ST103 through pump P101, said mixing tank ST103 being connected to an diaphragm less electrolytic cell EC101 through a pump P103 and said electrolytic cell EC101 being connected to transformer rectifier TR101 for supplying DC current and outlet of said electrolytic cell EC101 being connected to intermittent storage tank ST104 connected to ST105 through pump P105 where nitric acid solution is collected, the said intermittent storage tank ST104 is further connected to the mixing tank ST103 through pump P104 and another storage tank ST102 is connected to said mixing tank ST103 through pump P102 for providing water during electrolysis process:

In an embodiment of the present invention cathode used in diaphragm-less electrolytic cell is IrO₂ coated titanium.

In one embodiment of the present invention anode used in diaphragm-less electrolytic cell is Pt electroplated titanium.

In another embodiment of the present invention IrO₂ coated titanium cathodes and Pt electroplated titanium anodes are placed alternately inside the diaphragm-less electrolytic cell.

In another embodiment of the present invention an electrochemical process for the reduction of nitric acid concentration in industrial waste in electrochemical system comprising filling nitric acid to the storage tank ST101 at a rate ranging between 20 to 25 ml per hour followed by agitation and recirculation of the nitric acid continuously from the storage tank through the electrolytic cell at a cathodic current density of 500 to 600 A/m² for a time period ranging between 30 hours to 48 hours at a temperature ranging between 40° C. to 52° C. at a cell voltage ranging between 3 volts to 3.2 volts to obtain a nitric acid solution of reduced concentration of 0.9 M to 1.1 M concentration.

Still in another embodiment of the present invention nitric acid of concentration ranging between 3.9 M to 4 M is taken as input acid to the electrolytic cell.

Still in another embodiment of the present invention feeding rate of nitric acid to the storage tank is in the range of 20 ml per hour to 25 ml per hour.

Still in another embodiment of the present invention output rate of nitric acid solution is in the range of 20 ml per hour to 25 ml per hour.

Still in another embodiment of the present invention, recirculation rate of nitric acid solution is ranging between 150 ml per min to 300 ml per min.

Still in another embodiment of the present invention electrolytic reduction of the input acid solution occurs keeping the volume of the solution inside the cell constant.

### BRIEF DESCRIPTION OF THE DRAWING

FIG. 1: Process flow sheet for electrochemical destruction of nitric acid.

### DETAILED DESCRIPTION OF THE INVENTION

In the present invention, the nitric acid solution in about 4 M strength is reduced to around 1 M in a continuous mode. Sizing of electrodes and cell design were made. At the beginning of the electrolysis, the electrolytic cell is filled up with nitric acid of concentration 1 M. For agitation purpose the solution is continuously stirred externally in a reservoir/storage tank, followed by recirculation (Recirculation helps in improving the mass transfer rate in the electrolytic cell and hence it improves the efficiency of the operation) through and out of the cell. The outlet and inlet provided in the cell serve the purpose of feeding the solution into the reservoir/storage tank and passing the solution from the reservoir/storage tank into the cell, respectively. Solution with molarity 4 M is continuously added with a constant flow rate to the reservoir/storage tank, where each part of the added 4 M solution undergoes agitating action.

As 4 M solution is getting added into the 1 M stock solution present in the cell, it will increase the concentration of the total solution present in the cell. Because of the electrolytic reduction inside the cell, it becomes possible to maintain the concentration to about 1 M.

On the other side, at the outlet, same amount of solution is taken out of the cell continuously which is equal to the quantity of 4 M solution added to the reservoir/storage tank. The solution taken out of the cell at the outlet is of 1 M strength which is possible because of the electrolytic reduction occurring inside the cell. During the passage of the solution it gets reduced at the cathode forming NOₓ compounds.

In this manner, at one end 4 M nitric acid addition as input for concentration reduction and at the other end receiving 1 M nitric acid as product solution are synchronized keeping the volume of 1 M strength stock solution inside the electrolytic cell being constant.

Nitric acid solution contains hydrogen and nitrate ions which undergo cathodic reduction reactions in the electrolytic cell as shown in Table 1 to form NO₂, NO, and HNO₂. As a result, the concentration of the solution decreases.

The advantages of the process according to the invention are that an easily controllable continuous process sequence is assured and the maximum temperature of the solution is between 40 to 52° C. during electrolysis.

The current densities at the cathode determine the cathode potentials and here the current density range lies between 500 to 600 A/m². The current which is applied decides the production rate of NOₓ and the quantity of unreduced nitrate ion i.e. NO₃⁻.

In the present invention, recirculation of the solution takes place through pumping and gravity while travelling from cell to the tank and then to cell in a cyclic manner. The use of a diaphragm-less electrolytic cell helps in lowering the cell voltage and specific energy consumption for nitric acid reduction and avoids difficulties associated with frequent maintenance of the cell. In addition to this, suitable diaphragm material which can withstand chemical and corrosive atmosphere is not available.

In a solution, containing high concentration of nitric acid about 4 M as described in our invention, it is desirable to use a cathode which can withstand the highly corrosive action of nitric acid present in the solution. IrO₂ coated titanium is chemically inert to the concentrated nitric acid solution. However, the use of Fe, Cu, Zn, brass, and bronze materials as cathode may not be able to withstand the chemical action of nitric acid at a high concentration about 4 M. They will chemically react with nitric acid and get dissolved at a moderate rate into the solution although a negative potential is applied across them. Several researchers have worked on nitrate reduction using Fe, Cu, etc. as cathode materials where the concentration of nitrate ions in the electrolytic solution was very low. The present invention is related to the implementation of nitrate reduction phenomenon in nuclear waste processing where the waste solution contains nitric acid of about 4 M or 252 g/L. On the other hand, Pt electrode or Pt coated titanium can be used as an alternate in the present case. However, the use of Pt as cathode material is not found to be suitable since it adversely affects the process economy. Thus, the use of such electrodes other than IrO₂ coated titanium in the present invention cannot be encouraged.

The number of cathodes and anodes of specific dimensions in the electrolytic cell is decided depending on the requirement of area of cathodic reduction. For an electrolytic cell of 1 L capacity three number of cathodes and two number of anodes are found to be appropriate as per our experimental analysis. With the increase in the capacity of the electrolytic cell, the requirement of number of cathodes and anodes increases in order to achieve similar efficiency of the operation

Volume of waste is not increasing since in other processes specifically chemical processes, the addition of chemicals like formic acid to the nitric acid solution results in an increase in volume. However, in present invention the volume remains same throughout the process of electrochemical reduction of nitric acid solution.

This process is based only on electrochemical reactions and thereby the addition of external source of chemicals is avoided. Thus, the volume of the solution following the electrochemical reduction never increases. In present invention, it has been demonstrated that the developed electrochemical system is able to reduce 4 M nitric acid to a concentration of 1 M or less avoiding any increase in volume of the solution. Following the reduction of 4 M concentration to 1 M, the resultant solution can be evaporated and made concentrated of about 4 M and this concentrated solution can be processed further using our invented route of acid killing. Now it would be appropriate to state that our invention is helpful in reducing the nitric acid concentration as well as the volume of the solution.

In the present invention the reduction of concentration of nitric acid present in high level nuclear waste in a continuous mode without increasing the volume of waste unlike the conventional chemical processes.

The non obviousness of this process lies in carrying out the reduction of nitric acid in an electrolytic cell without any diaphragm using IrO₂ coated titanium as the cathode material.

Concentration of nitric acid is estimated by taking 1 ml of the electrolyte at regular interval and analyzed by conventional acid base titration method. In this method the corresponding acid was titrated against a primary base i.e. sodium carbonate using methyl orange indicator. A change in colour from pink to yellow indicates the end point and gives the concentration of nitric acid.

### EXAMPLES

The following example is given by way of illustration of the present invention and therefore should not be construed to limit the scope of the present invention.

### Example 1

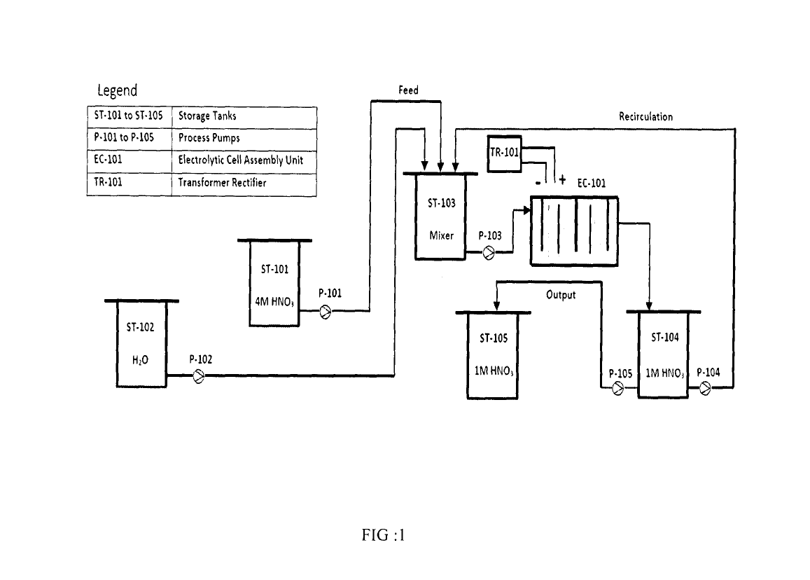

This example illustrates the reduction of nitrate (NO₃⁻) to nitrite (NO₂⁻) in the electrolytic cell (designed and developed) in a continuous manner. FIG. 1 shows a process scheme according to which the electrolytic cell is filled up with 1000 ml of 1.09 M nitric acid and the reservoir/storage tank with 200 ml of 1.09 M nitric acid. Three IrO₂ coated titanium cathodes and two platinum electroplated titanium anodes are positioned alternately inside the electrolytic cell.

For electrolytic reduction, an input of 3.9 M nitric acid is added to the reservoir/storage tank at a rate of 25 ml per hour and is stirred along with the solution present inside the reservoir/storage tank. The solution is recirculated continuously at a rate of 150 ml per min from the reservoir/storage tank through the electrolytic cell. Applied cathodic current density is 600 A/m². The feeding rate of input 3.9 M nitric acid is synchronized with the removal rate of output 1.09 M nitric acid, keeping the volume of the total solution constant i.e. 1200 ml. The cell voltage is found to be 3 volts and the temperature of the solution reaches 41° C. maximum.

This continuous experimental work is carried out for 48 hours and the concentration of the solution is found to be 1.11 M. For 48 hours with an input of 1200 ml 3.9 M, output of 1200 ml 1.11 M is obtained apart from 1200 ml of original 1.09 M solution initially present in electrolytic cell.

### Example 2

An electrolytic cell is filled up with 1200 ml nitric acid solution of molarity 1.12 M (including the solution present in the reservoir/storage tank for agitation purpose). Three IrO₂ coated titanium cathodes and two platinum electroplated titanium anodes are placed alternately inside the electrolytic cell. The cathodic current density is maintained at 500 A/m².

At a rate of 20 ml per hour the nitric acid solution of concentration level 4 M is added to the reservoir/storage tank and the mixed solution is pumped to the electrolytic cell. At the outlet of the cell the solution of reduced concentration, 1.10 M, is collected in a storage tank (as shown in FIG. 1) from where at a rate of 20 ml per hour the solution of 1.10 M concentration is transferred to another storage tank through a pump.

Both feeding rate of 4 M nitric acid solution and extracting rate of output 1.10 M nitric acid solution are being synchronized keeping the volume of the solution inside the cell being constant i.e. 1200 ml. The recirculation rate of the cell solution is kept at 150 ml per min.

During the electrolytic reduction of nitric acid the cell voltage is found to be 3.2 volts and the temperature of the solution varies from 40 to 43° C. This experiment is continued for 30 hours and due to electrolytic reduction of the input nitric acid of molarity 4 M, the concentration level of the output nitric acid is found to be 1.10 M.

### Example 3

An electrolytic cell is filled up with 1200 ml nitric acid solution of molarity 1.00 M (including the solution present in the reservoir/storage tank for agitation purpose). Three IrO₂ coated titanium cathodes and two platinum electroplated titanium anodes are placed alternately inside the electrolytic cell. The cathodic current density is maintained at 600 A/m².

At a rate of 25 ml per hour the nitric acid solution of concentration level 3.9 M is added to the reservoir/storage tank as an input and simultaneously solution of reduced concentration 0.9 M at a rate of 25 ml per hour is collected in a storage tank in a similar way as explained in Example 2. Both feeding rate of 3.9 M nitric acid solution and extracting rate of output 0.90 M nitric acid solution are being synchronized keeping the volume of solution inside the cell being constant i.e. 1200 ml. The recirculation rate of the cell solution is kept at 300 ml per min.

During the electrolytic reduction of nitric acid the cell voltage is found to be 3.2 volts and the temperature of the solution varies from 50 to 52° C. This experiment is continued for 48 hours and due to electrolytic reduction of the input nitric acid of molarity 3.9 M, the concentration level of the output nitric acid is found to be 0.90 M.

### ADVANTAGES

1) Use of diaphragm-less electrolytic cell avoids difficulties associated with frequent maintenance of the cell.
2) Use of non-consumable and/or corrosion resistant cathode and anode materials makes the process economic.
3) Electrolytic reduction of concentration level of high level liquid waste solution in a continuous mode.
4) It provides a safer and environment friendly process in comparison to chemical processes of reduction of nitric acid as in case of using formic acid.

We claim:

1) An electrochemical system for electrolytic reduction of nitric acid concentration in industrial waste comprising a storage tank ST101 connected to a mixing tank ST103 through pump P101, said mixing tank ST103 being connected to an diaphragm less electrolytic cell EC101 through a pump P103 and said electrolytic cell EC101 being connected to transformer rectifier TR101 for supplying DC current and outlet of said electrolytic cell EC101 being connected to intermittent storage tank ST104 connected to ST105 through pump P105 where nitric acid solution is collected, the said intermittent storage tank ST104 is further connected to the mixing tank ST103 through pump P104 and another storage tank ST102 is connected to said mixing tank ST103 through pump P102 for providing water during electrolysis process.

2) The system as claimed in claim 1, wherein cathode used in diaphragm-less electrolytic cell is IrO₂ coated titanium.

3) The system as claimed in claim 1, wherein anode used in diaphragm-less electrolytic cell is Pt electroplated titanium.

4) The system as claimed in claim 1, wherein IrO₂ coated titanium cathodes and Pt electroplated titanium anodes are placed alternately inside the diaphragm-less electrolytic cell.

5) An electrochemical process for the reduction of nitric acid concentration in industrial waste in electrochemical system as claimed in claim 1 comprising filling nitric acid to the storage tank ST101 at a rate ranging between 20 to 25 ml per hour followed by agitation and recirculation of the nitric acid continuously from the storage tank through the electrolytic cell at a cathodic current density of 500 to 600 A/m² for a time period ranging between 30 hours to 48 hours at a temperature ranging between 40° C. to 52° C. at a cell voltage ranging between 3 volts to 3.2 volts to obtain a nitric acid solution of reduced concentration of 0.9 M to 1.1 M concentration.

6) The process as claimed in claim 5, wherein nitric acid of concentration ranging between 3.9 M to 4 M is taken as input acid to the electrolytic cell.

7) The process as claimed in claim 5, wherein feeding rate of nitric acid to the storage tank is in the range of 20 ml per hour to 25 ml per hour.

8) The process as claimed in claim 5, wherein output rate of nitric acid solution is in the range of 20 ml per hour to 25 ml per hour.

9) The process as claimed in claim 5, wherein, recirculation rate of nitric acid solution is ranging between 150 ml per min to 300 ml per min.

10) The process as claimed in claim 5, wherein electrolytic reduction of the input acid solution occurs keeping the volume of the solution inside the cell constant.
